(19) United States
(12) Patent Application Publication
(10) Pub. No.: US 2011/0297716 A1
(43) Pub. Date: Dec. 8, 2011

(54) Foldable mount

(76) Inventor: Kawing Mo, Temple City, CA (US)

(21) Appl. No.: 12/802,326

(22) Filed: Jun. 3, 2010

(51) Int. Cl. B60R 11/00

(52) U.S. Cl. 224/559

(57) ABSTRACT

A foldable mounting structure for mounting electronic devices within a vehicle that includes a uniquely designed base and a suction-forming assembly connected to the base that includes a suction cup and an elongated arm to which the electronic devices can be connected. The elongated arm is movable relative to the base from a first folded position to a second extended position to cause a suction to be formed between the suction cup and a smooth mounting surface located within the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to mounting structures for supporting articles especially within vehicles. More particularly the invention concerns an improved mounting structure for mounting electronic devices within vehicles that comprises a base, a suction-forming assembly connected to the base that includes a suction cup and an elongated arm to which the electronic devices can be connected, the elongated arm being movable relative to the base from a first folded position to a second extended position to form a suction between the suction cup and a smooth mounting surface located within the vehicle.

2. Description of Related Art Including Information Disclosed Under 37 CRF 1.97 and 1.98

Not Applicable

### BRIEF SUMMARY OF THE INVENTION

It is an object of the present invention to provide an improved foldable mounting structure for mounting objects such as a GPS, a satellite radio, a PDA and like electronic components within a vehicle.

More particularly, it is an object of the invention to provide such a mounting structure that includes a uniquely designed base and a suction-forming assembly connected to the base that includes a suction cup and an elongated arm to which the electronic devices can be connected. Uniquely, the elongated arm which is movable relative to the base, from a first folded position to a second extended position, causes a suction to be formed between the suction cup and a smooth mounting surface located within the vehicle.

Another object of the invention is to provide an improved mounting structure of the character described in the preceding paragraph in which the suction can be broken by moving the elongated arm relative to the base from its extended position to its initial folded position.

Another object of the invention is to provide an improved mounting structure of the character described which, upon folding the elongated arm relative to the base into its folded position, renders the device quite compact for ease of storage and shipment.

Another object of the invention is to provide an improved mounting structure that is easy to use, comprises a minimum number of cooperating components and is economical to manufacture in large quantities.

### BRIEF DESCRIPTION OF SEVERAL VIEWS OF THE DRAWINGS

FIG. 1 is a generally perspective view of one form of the mounting structure of the present invention.

FIG. 2 is a generally perspective, exploded view of the mounting structure shown in FIG. 1, illustrating its use with a connector mechanism for inter-connecting an article with the folding arm of the structure.

FIG. 3 is a side elevational view of the mounting structure shown in FIG. 1, but broken away to show the internal construction.

FIG. 4 is a side elevational view similar to FIG. 3, but showing the mounting structure in a suction forming configuration.

### DETAILED DESCRIPTION OF THE INVENTION

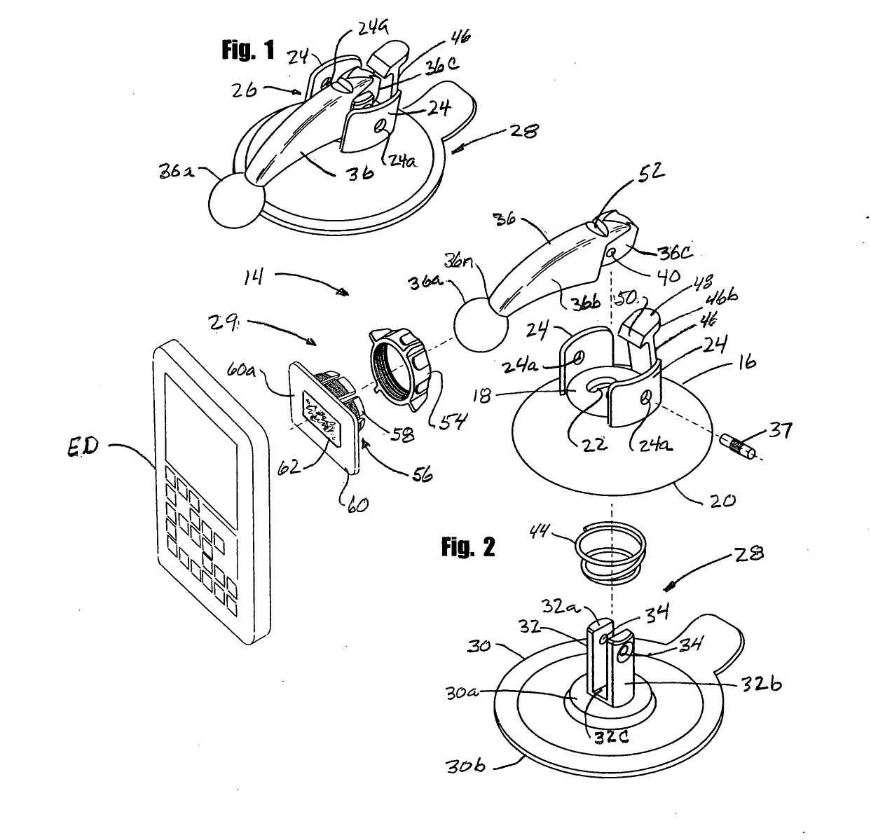

Referring to the drawings and particularly to FIGS. 1 and 2, one form of the mounting structure of the present invention for supporting objects within a vehicle is there illustrated. As best seen in FIG. 2, the mounting structure, which is generally designated by the numeral 14, here comprises a base 16 having a first, central surface 18, a concave second surface 20 and a central bore 22. Disposed on either side of first surface 18 is an upstanding curved wall 24. For a purpose presently to be described, each of the curved walls 24 is provided with a through bore 24a.

Connected to base 16 is the novel suction forming and release assembly 26 that here comprises a suction cup assembly 28 and an article support arm assembly 29. Suction cup assembly 28 includes a suction cup 30 having a central portion 30a and a peripheral portion 30b. Suction cup 30 is designed to be removably attached to a smooth surface such as a windshield of a vehicle. In a manner presently be described, the suction forming and release assembly 26 functions to form and release the suction developed by suction cup 30.

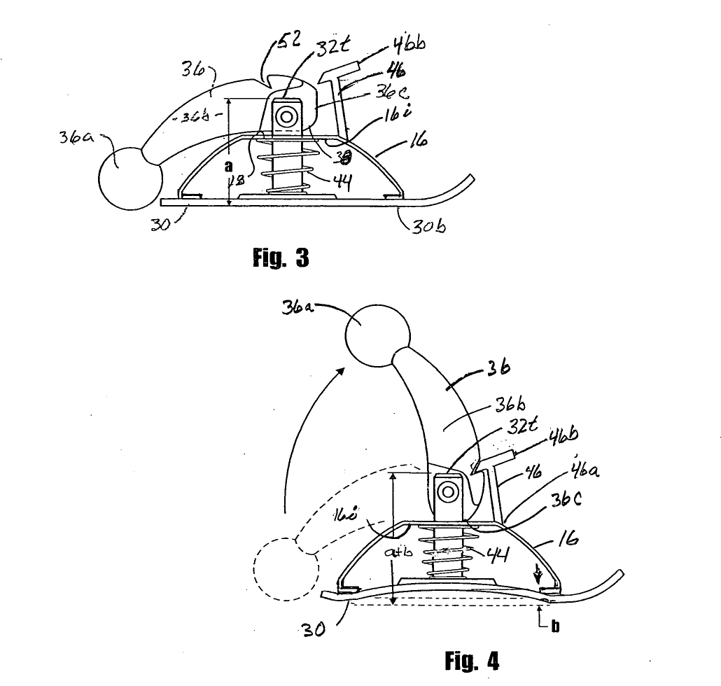

Connected to the central portion 30a of suction cup 30 is a drive member 32 that is reciprocally movable within the central bore 22 of the base 16 from the first at rest position shown in FIG. 3 to the second suction forming position shown in FIG. 4. As best seen in FIG. 2, drive member 32 is of a fork-like construction that includes spaced apart legs 32a and 32b and a bight portion 32c that is connected by any suitable manner, such as adhesive bonding, to the central portion 30a of the suction cup 30. For a purpose presently to be described, each of the legs 32a and 32b is provided with a transverse through bore 34.

Article support arm assembly 29 comprises an elongated arm 36 having a first, generally spherical shaped end portion 36a, an intermediate portion 36b and a second end portion 36c that is pivotally connected to the drive member 32 of the suction cup assembly 28 by means of a pivot pin 37. As best seen in FIGS. 3 and 4, the second end portion 36c of arm 36 has a curved, cam like surface 38 that is adapted to engage the first surface 18 of the base 16 when the arm 36 is moved relative to base 16 from the first folded position shown in FIG. 3 to the second extended position shown in FIG. 4.

Second end portion 36c is provided with a transverse through bore 40 that is coaxially aligned with the bores 34 provided in each of the legs 32a and 32b of the drive member. With this construction, when the arm is in the position shown in FIG. 1 of the drawings, the pivot pin 37 which is accessible through the bores 24a formed in curved wall 24 can be positioned within through bores 34 and 40. With the pivot pin in place, arm 36 can be moved from the folded position shown in FIG. 3 to the upright, operative, or suction forming position shown in FIG. 4. When the arm 36 is in its folded position, the top 32t of the drive member resides at a distance “a” from the bottom surface of the suction cup 30. However, as the arm 36 is moved into to the extended position shown in FIG. 4, the cam surface 36c of the arm engages the upper surface 30a of the suction cup causing the drive member 32 to move upwardly into the position shown in FIG. 4. As illustrated in FIG. 4, in this elevated operative position, the height of the drive member is “a+b”, where “b” is a distance between the bottom of the suction cup in the at rest position shown in FIG. 3 and the bottom of the suction cup at its elevated, suction inducing position shown in FIG. 4. As the drive member 32 is moved into the extended position shown in FIG. 4, the central portion of the suction cup 30 to which the drive member is attached will be moved upward relative to the smooth surface upon which it rests, thereby causing a suction to be formed between the suction cup and the smooth surface. When the arm 36 is returned to the folded, stowed position shown in FIG. 3, the drive member will be moved downwardly to the position shown in FIG. 3, thereby breaking the suction between the suction cup and the smooth surface upon which it rests, thereby permitting removal of the apparatus from the smooth surface.

As illustrated in the drawings, a coil spring 44, which forms a part of the suction cup assembly 28, circumscribes drive member 32. Coil spring 44 is strategically positioned between the upper surface of central portion 30a of the suction cup and the inner surface 16i of the base 16. As the drive member is moved upwardly in the manner described in the preceding paragraph, coil spring 44 will yieldably resist upward movement of the central portion of the suction cup. Upon movement of the arm 36 into the downward position shown in FIG. 3 of the drawings, coil spring 44 will urge the suction cup to return to its at rest position shown in FIG. 3 of the drawings.

Connected to and extending from the concave second surface of base 16 is a yieldably deformable locking member 46 that functions to lock arm 36 in the extended position shown in FIG. 4 of the drawings and to releasably prevent its return to the folded stowed position shown in FIG. 3. Locking member 46 has a lower extremity 46a that is connected to the upper surface of the base and an upper extremity 46b that includes a finger engaging portion 48 and a locking portion 50 (FIG. 2). Locking portion 50 is receivable within a notch 52 formed in arm 36 (FIGS. 2 and 3). The locking portion 50 of the yieldably deformable locking member is continuously urged to toward engagement with notch 52 and will automatically engage the notch as the arm 36 is moved into its extended position shown in FIG. 4 of the drawings. To release the locking member from the locked position shown in FIG. 4, the user must exert a downward force on the finger engaging portion 48 of the locking member so as to remove it from the notch 52 and permit the arm to be returned to its stowed position.

Turning once again to FIG. 2 of the drawings, the form of the apparatus of the invention there shown includes attachment means for attaching an electronic device such as device “ED” to the end portion 36a of the foldable arm 36. This attachment means here includes a threaded ring 54 that is receivable about the neck portion 36n of the arm 36 and a connector plate assembly 56. Connector plate assembly 56 includes a threaded connector portion 58 that can be threadably connected to ring 54 and a connector plate 60 having a planar connector surface 60a. Provided on surface 60a of the connector plate is an article connector means here shown as an adhesive pad 62 to which the electronic device ED can be removably affixed. The connector means can take various forms well known to those skilled in the art, including connector elements of the character illustrated and described in U.S. Publication No. 2009-0294608. U.S. Publication No. 2009-0294608 which was published on Dec. 3, 2009, is hereby incorporated herein by reference as though fully set forth herein.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A mounting structure for supporting objects within a vehicle comprising a base having a first surface, a concave second surface and a central bore and a suction-forming and release assembly connected to said base, said suction-forming assembly comprising:
(a) a suction cup assembly comprising:
(i) a suction cup designed to be removably attached to a smooth surface, said suction cup having a central portion and a peripheral portion;
(ii) a drive member connected to said central portion of said suction cup, said drive member having a transverse through bore and being reciprocally movable within the central bore of said base from the first at rest position to a second suction forming position; and
(b) an article support arm assembly pivotally connected to said drive member of said suction cup assembly for moving said drive member from said first at rest position to said second suction forming position, said article support arm assembly, comprising:
(i) an elongated arm having a first end portion, an intermediate portion and a second, curved end portion, said curved end portion having a transverse bore co-axially aligned with said transverse bore of said drive member, said elongated arm being movable relative to said base from a first folded position to a second extended position; and
(ii) a pivot pin disposed within said transverse bore of said drive member and within said transverse bore of said curved end portion of said elongated arm.

2. The mounting structure as defined in claim 1 in which said base further includes a yieldably deformable locking member operably associated with said elongated arm for locking said elongated arm in said extended position.

3. The mounting structure as defined in claim 1 in which said suction cup assembly further comprises a coil spring circumscribing said drive member for yieldably resisting movement of said drive member toward said second suction forming position.

4. The mounting structure as defined in claim 1 further including attachment means for attaching an electronic device to said first end portion of said elongated arm.

5. The mounting structure as defined in claim 4 in which said attachment means comprises a threaded ring connected to said elongated arm and a connector assembly connected to said threaded ring, said connector assembly comprising a threaded connector portion connected to said threaded ring and a connector plate connected to said threaded connector portion.

6. A mounting structure for supporting objects within a vehicle comprising:
(a) a base having a first surface, a concave second surface and a central bore and including a yieldably deformable locking member extending from said concave second surface;
(b) a suction-forming and release assembly connected to said base, said suction-forming and release assembly comprising:
(i) a suction cup assembly comprising:
a. a suction cup designed to be removably attached to a smooth surface, said suction cup having a central portion and a peripheral portion;
b. a drive member connected to said central portion of said suction cup, said drive member having a transverse through bore and being reciprocally movable within the central bore of said base from the first at rest position to a second suction forming position; and
c. a coil spring circumscribing said drive member for yieldably resisting movement of said drive member toward said second suction forming position; and
(ii) an article support arm assembly pivotally connected to said drive member of said suction cup assembly for moving said drive member from said first at rest position to said second suction forming position, said article support arm assembly, comprising:
a. an elongated arm having a first generally spherically shaped end portion, an intermediate portion and a second, curved end portion, said curved end portion having a transverse bore co-axially aligned with said transverse bore of said drive member, said elongated arm being movable relative to said base from a first position to a second extended position; and
b. a pivot pin disposed within said transverse bore of said drive member and within said transverse bore of said curved end portion of said elongated arm.

7. The mounting structure as defined in claim 6 in which said elongated arm is provided with a notch and in which said yieldably deformable locking member includes an upper extremity having a finger engaging portion and a locking portion receivable within said notch.

8. The mounting structure as defined in claim 6 in which said drive member includes a pair of spaced apart legs and in which said second end portion of said elongated arm is disposed between said spaced apart legs.

9. The mounting structure as defined in claim 6 further including attachment means for attaching an electronic device to said first end portion of said elongated arm.

10. The mounting structure as defined in claim 8 in which said attachment means comprises a threaded ring connected to said elongated arm and a connector assembly connected to said threaded ring, said connector assembly comprising a threaded connector portion connected to said threaded ring and a connector plate connected to said threaded connector.
